(19) United States
(12) Patent Application Publication
(10) Pub. No.: US 2018/0260037 A1
(43) Pub. Date: Sep. 13, 2018

(54) RANDOM-VARIATION NUMERIC KEYPAD

(71) Applicant: JETEAZY SYSTEM CO., LTD., Hsinchu City (TW)

(72) Inventor: CHENG-HSIN TSAI, HSINCHU CITY (TW)

(21) Appl. No.: 15/456,688

(22) Filed: Mar. 13, 2017

(51) Int. Cl. G06F 3/023; G06F 21/83

(52) U.S. Cl. CPC G06F 3/0238; H01L 27/3244; G06F 21/83

(57) ABSTRACT

A random-variation numeric keypad has a baseboard, multiple numeric buttons, multiple function buttons and a random-variation button. The multiple numeric buttons, the multiple function buttons and the random-variation button are arranged on a surface of the baseboard. When the random-variation button is activated, the numeric buttons randomly display numbers. The numbers displayed on the multiple numeric buttons are arranged in random orders to prevent shoulder-surfers from obtaining the password.

### BACKGROUND OF THE INVENTION

### 1. Field of the Invention

The present invention relates to a numeric keypad, especially a keypad capable of randomly arranging numeric buttons.

### 2. Description of the Prior Arts

With reference to FIG. 4, a keypad 41 is an important component for a computer 42, an automated teller machine (ATM), a point of sale (POS) 43, or a coded lock 44.

Generally, a password is input using a numeric keypad having numeric buttons, such as inputting a password to authenticate an authorized user for cash withdrawal. However, if another person snoops a user's finger movement when the user is entering the password via the numeric keypad, as shown in FIG. 5, the password may be easily captured and financial loss is caused, since the numeric buttons for inputting the password are arranged regularly on the keypad.

With reference to FIG. 5, the numbers are attached to the numeric buttons 51 of the numeric keypad 50 by laser printing or pasting. To avoid shoulder surfing, a shield may be mounted on the numeric keypad to partially hide the numeric buttons 51, and thus shoulder surfers are not easy to observe the movement of the finger when the user is entering the password. However, the protection effect of the shield is still inadequate.

Thus the present numeric keypad needs to be improved for preventing another person from obtaining the password based on the locations of button pressing.

### SUMMARY OF THE INVENTION

The present invention provides a numeric keypad for protecting the numbers input through the numeric keypad from shoulder surfing. The numeric keypad comprises a baseboard, multiple numeric buttons, multiple function buttons and a random-variation button. The multiple numeric buttons are arranged on a surface of the baseboard for displaying numbers. The multiple function buttons are arranged on the surface of the baseboard. The random-variation buttons are arranged on the surface of the baseboard, wherein when the random-variation button is pressed, the multiple numeric buttons randomly display the numbers.

Because the numbers displayed on the multiple numeric buttons of the present invention are not distributed in a regular arrangement, other person would not easily recognize the numbers input through the numeric keypad. Thus the password is protected.

### BRIEF DESCRIPTION OF THE DRAWINGS

FIG. 1 is a perspective view of a random-variation numeric keypad of the present invention.

FIG. 2 is a perspective view of the random-variation numeric keypad with numbers arranged randomly of the present invention.

FIG. 3 is an operational view of using the random-variation numeric keypad to input numbers.

FIG. 4 is a schematic view showing different applications of a conventional numeric keypad.

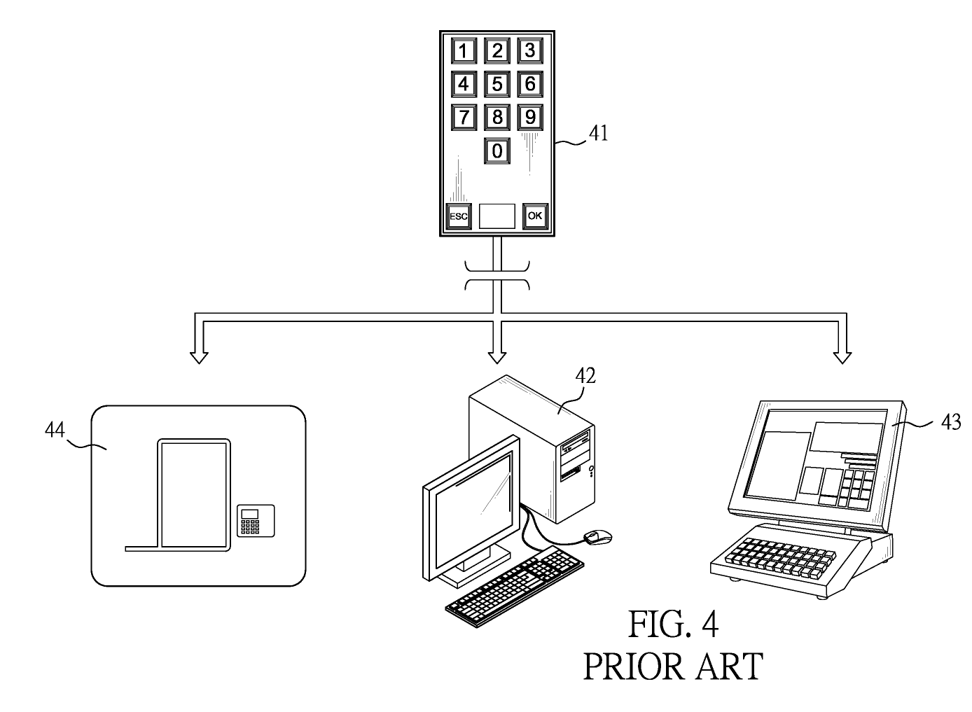

FIG. 5 is a perspective view of a conventional numeric keypad.

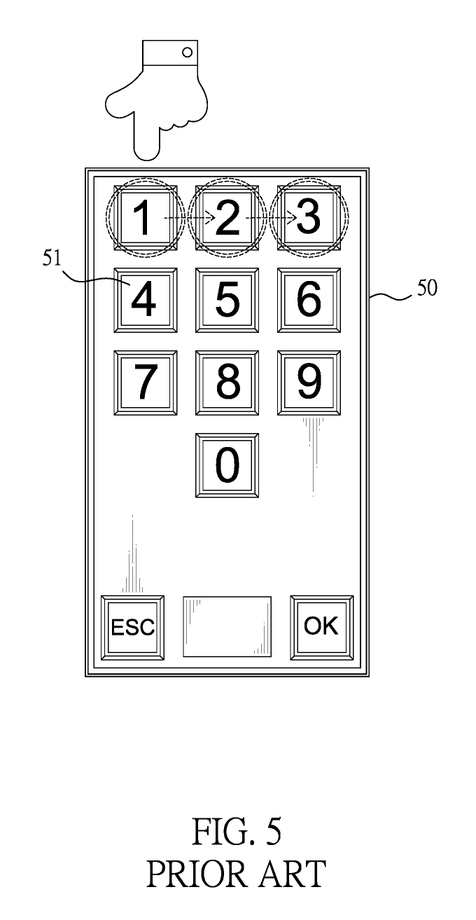

### DETAILED DESCRIPTION OF THE INVENTION

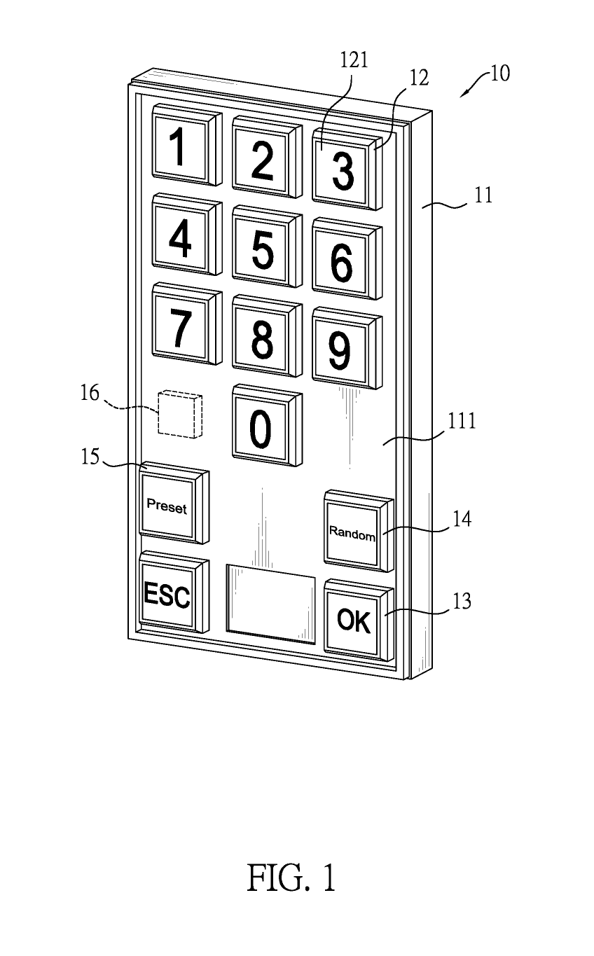

As shown in FIG. 1, a random-variation numeric keypad 10 comprises a baseboard 11, multiple numeric buttons 12, multiple function buttons 13 and a random-variation button 14.

The multiple numeric buttons 12, the multiple function buttons 13 and the random-variation button 14 are arranged on a surface 111 of the baseboard 11, and may be arranged in a matrix configuration. In one embodiment, the multiple numeric buttons 12 may be adjacent to the multiple function buttons 13 and the random-variation button 14 may be arranged next to the multiple numeric buttons 12 or the multiple function buttons 13. However, the positions of these buttons in the present invention are not limited by the embodiment.

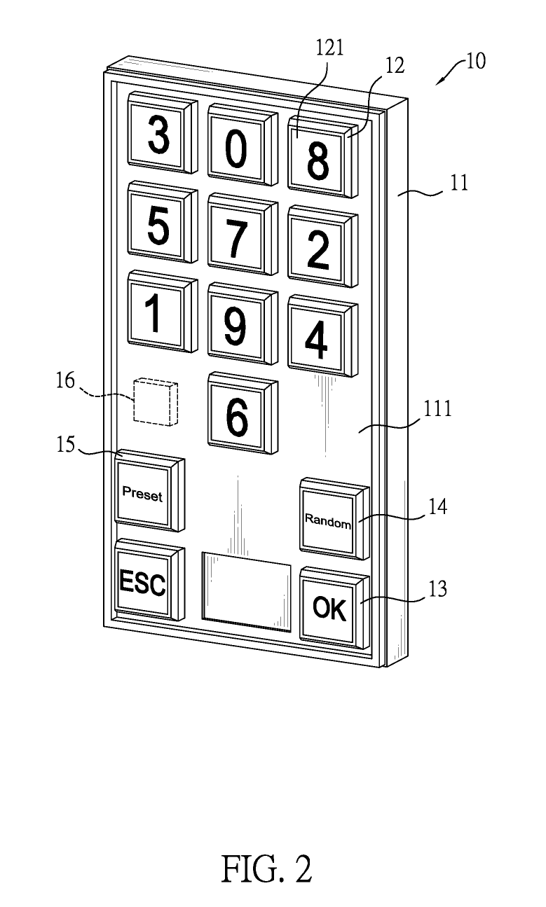

Preferably, there are ten numeric buttons 12. In another embodiment, the amount can be more than ten. A display panel 121 is arranged on a surface of each numeric button 12 for electrically displaying a number. Each display panel 121 may be manufactured using light emitting diodes (LEDs), organic light emitting diodes or thin film transistor technologies such as indium gallium zinc oxide. In this preferred embodiment, the numeric buttons 12 may be generally arranged in a regular configuration in which the numbers are sequentially sorted from largest to smallest or from smallest to largest. However, when the random-variation button 14 is pressed, the original sequence of numbers on the numeric buttons 12 becomes a random arrangement as shown in FIG. 2.

The numeric keypad 10 may further comprise a preset button 15, or so called a reset button. When the preset button 15 is pressed, the numbers displayed by the numeric buttons 12 are reset to the regular arrangement.

In the present invention, the numeric keypad 10 has a built-in random-variation unit 16. The random-variation unit 16 is electrically connected to the random-variation button 14 and the numeric buttons 12. A drive signal is generated when the random-variation button 14 is pressed and is transmitted to the random-variation unit 16. When the random-variation unit 16 receives the drive signal, the random-variation unit 16 drives the numeric buttons 12 to vary their numbers displayed on the display panels 121. The random-variation unit 16 may be composed of a microprogrammed processor.

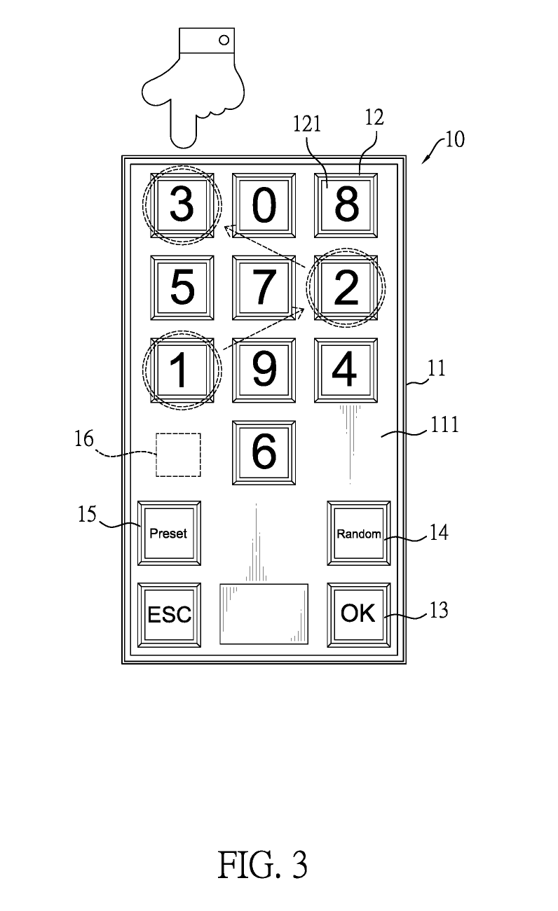

With reference to FIG. 3, when the numbers displayed by the numeric buttons 12 are arranged randomly, the positions for inputting numbers 1, 2 and 3 are not distributed regularly. That means a user needs to push the numeric button 12 at the lower left corner for inputting 1, the numeric button 12 at the middle right side for inputting 2, and the numeric button 12 at the top left corner for inputting 3. By randomly displaying the numbers on the numeric buttons 12, other persons would not easily recognize the number being entered. As in this embodiment, a shoulder surfer who snoops the input of the three numbers may incorrectly recognize the numbers being sequentially entered are 7, 6 and 1.

The numeric buttons 12 of the present invention can vary the sequence of the numbers displayed by the numeric buttons. Another person is unable to easily recognize the numbers being entered or even will have a wrong guess of the numbers entered. Thus the password would not be obtained by shoulder surfing and the security of the numeric keypad is improved.

What is claimed is:

1. A random-variation numeric keypad comprising:
a baseboard;
multiple numeric buttons arranged on a surface of the baseboard for displaying numbers;
multiple function buttons arranged on the surface of the baseboard;
a random-variation button arranged on the surface of the baseboard, wherein when the random-variation button is pressed, the multiple numeric buttons randomly display the numbers.

2. The random-variation numeric keypad as claimed in claim 1, wherein a random-variation unit is further mounted in the baseboard and is electrically connected to the random-variation button and the numeric buttons.

3. The random-variation numeric keypad as claimed in claim 2, wherein the random-variation unit is a microprogrammed processor.

4. The random-variation numeric keypad as claimed in claim 1, wherein a preset button is further arranged on the surface of the baseboard for resetting the multiple numeric buttons to display the numbers in a regular order.

5. The random-variation numeric keypad as claimed in claim 1, wherein each numeric button comprises a display panel for displaying the number.

6. The random-variation numeric keypad as claimed in claim 2, wherein each numeric button comprises a display panel for displaying the number.

7. The random-variation numeric keypad as claimed in claim 5, wherein the display panel is a light emitting diode-based panel.

8. The random-variation numeric keypad as claimed in claim 5, wherein the display panel is an organic light emitting diode-based panel.

9. The random-variation numeric keypad as claimed in claim 5, wherein the display panel is a thin film transistor-based panel.

10. The random-variation numeric keypad as claimed in claim 6, wherein the display panel is a light emitting diode-based panel.

11. The random-variation numeric keypad as claimed in claim 6, wherein the display panel is an organic light emitting diode-based panel.

12. The random-variation numeric keypad as claimed in claim 6, wherein the display panel is a thin film transistor-based panel.
